(19) United States
(12) Patent Application Publication
(10) Pub. No.: US 2010/0325565 A1
(43) Pub. Date: Dec. 23, 2010

(54) APPARATUS AND METHODS FOR GENERATING GRAPHICAL INTERFACES

(75) Inventors: Matthew Moore Skinner, Parker, CO (US); Michael Alexander, Denver, CO (US)

Correspondence Address: EchoStar Technologies, L.L.C.;Legal Department, 9601 SOUTH MERIDIAN BOULEVARD, ENGLEWOOD, CO, 80112, US

(73) Assignee: EchoStar Technologies, L.L.C., Englewood, CO (US)

(21) Appl. No.: 12/486,683

(22) Filed: Jun. 17, 2009

(51) Int. Cl. G06F 3/00; G06F 17/00

(52) U.S. Cl. 715/762; 715/234

(57) ABSTRACT

The various embodiments described herein provide for the layout and rendering of graphical interfaces to be independent from the underlying functionality of the application. The layout functionality for a graphical interface of an application is detached from the application itself, allowing the application and its associated graphical interface to be moved to different platforms utilizing different graphical application programming interfaces (APIs).

### BACKGROUND

In many computing systems, the generation of graphical interfaces is coded into the application software. When the graphical interfaces are coded directly into the application software, the application becomes difficult to modify or move to different hardware platforms, which may utilize different commands to output widgets comprising the graphical interface. Additionally, when the graphical interface is coded directly into the application software, it becomes more difficult for the application to support multiple windows or users at the same time.

### BRIEF DESCRIPTION OF THE DRAWINGS

The same number represents the same element or same type of element in all drawings.

FIG. 1 illustrates an embodiment of an entertainment system.

FIG. 2 illustrates an embodiment of a television receiver of FIG. 1.

FIG. 3 illustrates a block diagram of software modules operating on the processor of FIG. 2.

FIG. 4 illustrates a process for presenting a graphical interface.

FIG. 5 illustrates a process for presenting a graphical interface.

FIG. 6 illustrates an example of a graphical interface outputted by the television receiver of FIG. 1.

FIG. 7 illustrates the hierarchy of the components in the graphical interface of FIG. 6.

FIG. 8 illustrates an embodiment of navigation of the hierarchy of FIG. 7

### DETAILED DESCRIPTION OF THE DRAWINGS

The various embodiments described herein generally provide apparatus, systems and methods which facilitate the reception, processing, and outputting of presentation content. More particularly, the various embodiments described herein provide for the layout and rending of graphical interfaces to be independent from the underlying functionality of the application. In at least one embodiment, the layout functionality is detached from the rendering functionality, allowing the application and its associated graphical interface to be moved to different platforms utilizing different graphical application programming interfaces (APIs).

In at least one embodiment, a computing device comprises a storage medium that stores at least one asset relating to at least one graphical interface. As used herein, an asset refers to any information or data describing or used in the layout of a graphical interface. In at least one embodiment, an asset may include a data file that describes the widgets and other elements comprising the graphical interface. In some embodiments, assets may include graphical elements included within a graphical interface, such as images, widgets, data displayed in the graphical interface and the like. The computing device further includes one or more processors and an application module operating on the processor. The application module is associated with particular functionality of the computing device and identifies a graphical interface associated with the functionality. Also operating on the processor is an application independent screen management module. The screen management module is operable to receive a communication from the application module identifying the graphical interface. The screen management module initiates retrieval of the asset from the storage medium and identifies the layout of the graphical interface based on the asset. The computing device further comprises an output interface that receives the graphical interface and outputs the graphical interface for presentation by a presentation device.

In at least one embodiment, a computing device comprises a storage medium that stores a graphical interface including a plurality of widgets. The plurality of widgets are arranged in a hierarchical structure, such as a tree structure. The computing device further includes an output interface operable to output the graphical interface to a presentation device. The graphical interface includes a focus associated with a particular one of the widgets. The computing device further includes an input interface operable to receive user input requesting to move a focus of the graphical interface. A processor of the computing device is operable to identify a first of the widgets holding the focus in the graphical interface and traverse the tree structure to identify a second of the widgets meeting a criterion of the user input. The processor is further operable to determine whether the second widget is capable of holding the focus and responsive to determining that the second widget is capable of holding the focus, commanding the output interface to output the focus on the second widget in the graphical interface.

In at least one embodiment, the various functionality of a computing device may be divided into discrete components which cooperate to output a graphical interface for viewing by a user. One or more applications operate on the apparatus to perform various functionality. For example, one application may be associated with an electronic programming guide, another application may be associated with a system menu and another application may be associated with a weather forecast. One or more screen management modules are associated with screens for one or more of the applications. The screen management modules control the layout and widget setup for the graphical interfaces. The screen management modules communicate with the associated applications to receive an identification of a particular graphical interface and manage the layout of the graphical interface for presentation to a user. An output management module provides an interface for communication between the screen management module and the underlying hardware operable for generating the output displayed by a presentation device. In other words, the output management module controls the drawing and animation of widgets for viewing by the user. The output management module may be configured to interact with various rendering libraries, such as OpenGL, depending on desired design criteria. The output interface outputs the rendered graphical interface for presentation by an associated presentation device.

The apparatus may further include an input management module that receives input from various devices, such as keyboards, remote controls, mice, microphones and the like. The input management module translates the input into a format compatible with the screen management module. The input management module then transmits the translated input to the screen management module for further processing. The screen management module may then process the input and/or provide the input to the associated application.

The described structure allows for applications to be independent from the rendering of the associated graphical interface. Different input manager and output management modules may be provided to interact with different hardware platforms, including different input devices, graphics controllers and the like. The screen management module offers independence between the applications and the input/output managers and interfaces. The screen management module controls the interfacing between the applications and the input/output interfaces such that the application may specify a particular graphical interface for presentation and the screen management module controls the output of the graphical interface. Similarly, the screen management module controls the reception of user input and interfacing between the applications and the input interfaces.

For convenience, the concepts presented herein are frequently described with reference to a television receiver (e.g., a set-top box) or similar system that is capable of receiving television signals and generating video imagery on a display. However, the teachings described herein are not limited to television receivers and may be readily adapted and deployed in any other type of computing system. Examples of other computing systems that could incorporate the concepts described herein include personal computers, servers, digital cameras, audio or video media players, audio/video systems and components (e.g., compact disc or digital video disc players, audio or video components associated with automobiles, aircraft or other vehicles, stereo receivers and/or amplifiers, jukeboxes, and/or the like), portable telephones and/or any other devices or systems. It is to be appreciated that any device or system that outputs a graphical interface for display could benefit from the concepts described herein.

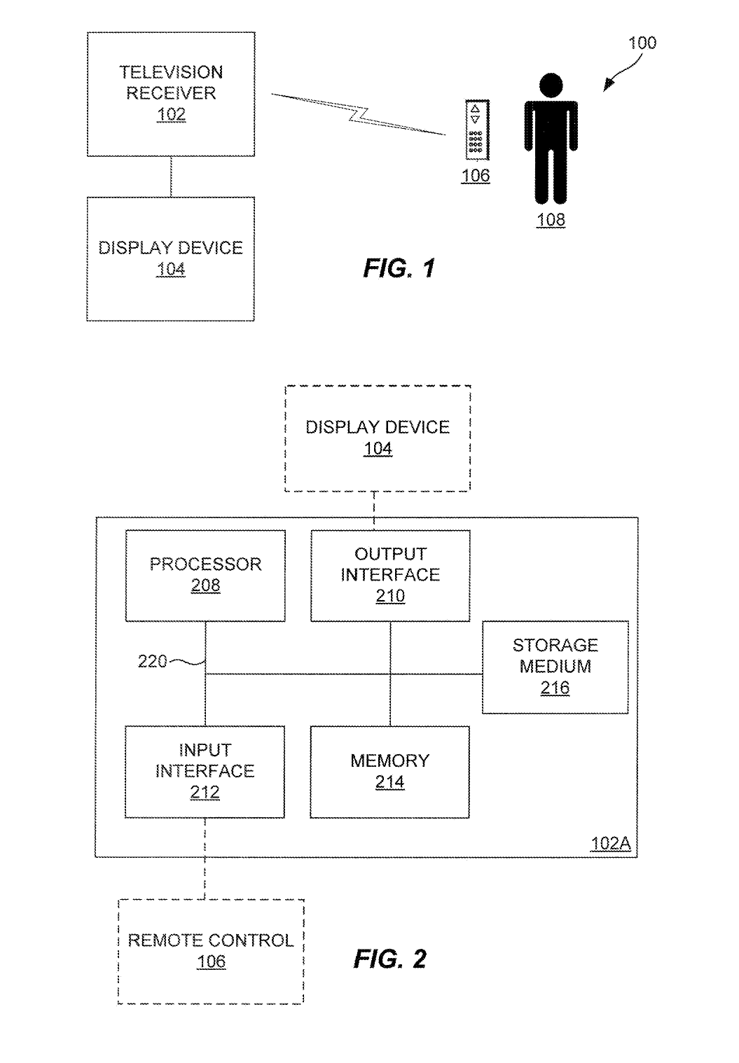

FIG. 1 illustrates an embodiment of an entertainment system 100. The entertainment system 100 presents content to a user 108. In at least one embodiment, the content presented to the user 108 includes an audio/video stream, such as a television program, movie or other recorded content and the like. The entertainment system 100 includes a television receiver 102, a display device 104 and a remote control 106. Each of these components is discussed in greater detail below. The entertainment system 100 may include other devices, components or elements not illustrated for the sake of brevity.

The television receiver 102 is operable to receive content from one or more content sources (not shown in FIG. 1) and output the received content for presentation by the display device 104. More particularly, the television receiver 102 is operable to receive, demodulate and output a television signal from a programming source, such as a satellite, cable, internet, terrestrial or other type of television transmission signal. The television receiver 102 may receive an audio/video stream in any format (e.g., analog or digital format). Likewise, the television receiver 102 may output the audio/video stream for presentation by the display device 104 in any type of format. In at least one embodiment, the television receiver 102 is a set-top box (e.g., a satellite or cable television receiver or converter box) or other similar device that processes and provides one or more audio and/or video output streams to the display device 104 for presentation to the user 108.

The television receiver 102 may be further configured to output for display menus and other information that allow a user 108 to control the selection and output of content by the television receiver 102. For example, as described in further detail below, the television receiver 102 may output electronic programming guide menus for review by the user 108. The television receiver 102 may also output a preference menu or other type of menu for receiving input that specifies or controls the operation of the television receiver 102. Some menus outputted by the television receiver 102 may manipulate the output of content by the television receiver 102.

In at least one embodiment, the television receiver 102 includes an integrated digital video recorder (DVR) operable to record video signals, corresponding with particular television programs, for subsequent viewing by the user 108. These programs may be selected for recording from within the electronic programming guide or may be inputted through other displayed menus, such as menus for setting manual recording timers. In at least one embodiment, the television receiver 102 displays a selection menu allowing the user 108 to select particular recordings for playback.

The display device 104 may comprise any type of device capable of receiving and outputting a video signal in any format. Exemplary embodiments of the display device 104 include a television, a computer monitor, a liquid crystal display (LCD) graphical interface, a touch screen interface and a projector. The display device 104 and the television receiver 102 may be communicatively coupled through any type of wired or wireless interface. For example, the display device 104 may be communicatively coupled to the television receiver 102 through a coaxial cable, component or composite video cables, an HDMI cable, a VGA or SVGA cable, a Bluetooth or WiFi wireless connection or the like.

It is to be appreciated that the television receiver 102 and the display device 104 may be separate components or may be integrated into a single device. For example, the television receiver 102 may comprise a set-top box (e.g., a cable television or satellite television receiver) and the display device 104 may comprise a television communicatively coupled to the set-top box. In another example, the television receiver 102 and the display device 104 may be embodied as a laptop with an integrated display screen or a television with an integrated cable receiver, satellite receiver and/or DVR.

The remote control 106 may comprise any system or apparatus configured to remotely control the output of content by the television receiver 102. The remote control 106 may minimally include a transmitter, an input device (e.g., a keypad) and a processor or control logic for controlling the operation of the remote control 106. The remote control 106 may communicate commands to the television receiver 102 requesting to playback content, temporally move through content (e.g., fast-forward or reverse), adjust the volume, access electronic programming guides, set or edit recording timers, edit preferences of the television receiver and the like. In some embodiments, the remote control 106 may additionally be configured to remotely control the display device 104. The remote control 106 may communicate with the television receiver 102 and/or the display device 104 through any type of wireless communication medium, such as infrared (IR) signals or radio-frequency (RF) signals.

The remote control 106 may include any type of man-machine interface for receiving input from the user 108. For example, the remote control 106 may include buttons for receiving input from the user 108. In at least one embodiment, the remote control 106 includes a touch pad for receiving input from the user 108.

The remote control 106 may be further operable to control the operation of the display device 104. For example, the display device 104 may comprise a television that is remotely controlled by the remote control 106 using IR or RF signals. In at least one embodiment, the remote control 106 may be integrated with the display device 104. For example, the remote control 106 and the display device 104 may comprise a touch screen display. The remote control 106 may also be integrated with the television receiver 102. For example, the remote control 106 may comprise buttons of the television receiver 102, such as an integrated keyboard of a laptop or a front panel display with buttons of a television receiver or other type of entertainment device.

FIG. 2 illustrates an embodiment of a television receiver of FIG. 1. The television receiver 102A includes a processor 208, an output interface 210, an input interface 212, a memory 214 and a storage medium 216. The components of the television receiver 102A may be communicatively coupled together by one or more data buses 220 or other type of data connections.

The processor 208 is operable for controlling the operation of the television receiver 102A. As used herein, processor 208 refers to a single processing device or a group of inter-operational processing devices. The operation of processor 208 may be controlled by instructions executable by processor 208. Some examples of instructions are software, program code, and firmware. Various embodiments of processor 208 include any sort of microcontroller or microprocessor executing any form of software code.

The processor 208 is communicatively coupled to the memory 214, which is operable to store data during operation of the processor 208. Such data may include software and firmware executed by the processor 208 as well as system and/or program data generated during the operation of the processor 208. Memory 214 may comprise any sort of digital memory (including any sort of read only memory (ROM), RAM, flash memory and/or the like) or any combination of the aforementioned.

The television receiver 102A also includes a storage medium 216, which is any kind of mass storage device operable to store files and other data associated with the television receiver 102A. In at least one embodiment, the storage medium 216 comprises a magnetic disk drive that provides non-volatile data storage. In another embodiment, the storage medium 216 may comprise flash memory. It is to be appreciated that the storage medium 216 may be embodied as any type of magnetic, optical or other type of storage device capable of storing data, instructions and/or the like. The storage medium 216 may also be referred to herein as “secondary memory.” In at least one embodiment, the storage medium 216 stores assets that are utilized to generate graphical interfaces. The assets may include data files that describe the layout of the graphical interfaces as well as images, data, widgets and the like contained within the graphical interface.

The television receiver 102A also includes an output interface 210 operable to interface with the display device 104. More particularly, the output interface 210 is operable to output information for presentation by the display device 104 (see FIG. 1). The output interface 210 may be operable to output any type of presentation data to the display device 104, including audio data, video data, audio/video (A/V) data, textual data, imagery or the like. In other embodiments, the output interface 210 may comprise a network interface operable to transmit data to other components, devices or elements, such as other computers, servers and the like. The output interface 210 may receive data from the processor 208 and/or other components of the television receiver 102A for output to the display device 104 (see FIG. 1).

The input interface 212 is operable to interface with one or more input devices, such as the remote control 106 (see FIG. 1). The input device may comprise any type of device for inputting data to the television receiver 102A. More particularly, data received from the input device may be used to control the operation of the processor 208 and/or the output of data to the display device 104. The input interface 212 and the remote control 106 may be communicatively coupled using any type of wired or wireless connection, including USB, WiFi, infrared and the like. In some embodiments, the input interface 212 may comprise a wireless receiver for receiving any type of RF or IR communication from the remote control 106. Exemplary input devices include keyboards, mice, buttons, joysticks, microphones, remote controls, touch pads and the like.

Those of ordinary skill in the art will appreciate that the various functional elements 208 through 220 shown as operable within the television receiver 102A may be combined into fewer discrete elements or may be broken up into a larger number of discrete functional elements as a matter of design choice. For example, the processor 208, the output interface 210 and/or the input interface 212 may be combined into a single processing module. Thus, the particular functional decomposition suggested by FIG. 2 is intended merely as exemplary of one possible functional decomposition of elements within the television receiver 102A.

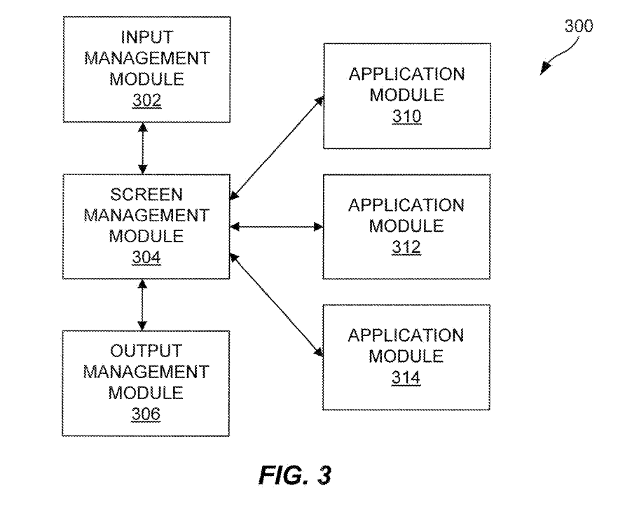

As described above, in at least one embodiment, the television receiver 102A operates various software modules that separate the generation of graphical interfaces from the associated application software. FIG. 3 illustrates a block diagram 300 of various software modules operating on the processor 208 of FIG. 2. This includes an input management module 302, a screen management module 304, an output management module 306 and one or more application modules 310, 312 and 314. The software modules in FIG. 3 separate the functionality of the application modules 310-314 from the generation and rendering of the associated graphical interfaces as well as the receipt of user input. Thus, the application modules 310-314 may be moved to different hardware platforms and connected with appropriate modules that interface with the underlying hardware. Each of the components 302-314 may be operated as a process, thread or task depending on desired design criteria.

The input management module 302 is responsible for handling user inputs from the remote control 106 and/or other input devices. More particularly, the input management module 302 interfaces with the input interface 212 to receive input from the remote control 106. The input may comprise any type of signal indicative of user input, such as key presses, pointer coordinates, user menu selections and the like. In at least one embodiment, the input manager module 302 is operable to translate the user input into a format compatible with the screen management module 304.

As described above, the screen management module 304 may be configured to be independent from the hardware of the television receiver 102A. The screen management module 304 is operable to manage graphical interface layouts, navigations and focus elements. Thus, in at least one embodiment, the input management module 302 is operable to interface with particular hardware to receive input and translate the input into a common format compatible with the screen management module 304. For example, the input interface 212 (see FIG. 2) may receive a signal from the remote control 106 indicative of a particular key press and the input management module 302 may process the signal to convert the key press into a format compatible with the screen management module 304.

In at least one embodiment, the input management module 302 includes a key handler that receives key commands and/or button presses captured by associated input devices. For example, key commands may be received from an associated keyboard or button presses may be received from an associated remote control. The key handler translates the received key/button presses for processing by the screen management module 304. The input management module 302 may also include a pointer handler that determines the location for a cursor that will be drawn on screen based on signals received from an input device, such as a touch pad, mouse or other pointing device. In some embodiments, the pointer handler may interpret quick motions of the input device as key presses or other input. For example, a quick sweep left to right of the remote control 106 may be interpreted as a right key push and may be converted into an appropriate key command by the input management module 302 for processing by the screen management module 304.

The screen management module 304 is operable to control the layout of graphical interfaces for the application modules 310-314. The screen management module 304 operates as an interface between the application modules 310-314 and the output management module 306 and/or the input management module 302. Rules implemented by the screen management module 304 ensure that the behavior of all graphical interfaces are controlled and standard between multiple graphical interfaces and widgets within the graphical interface. Communications between the screen management module 304 and the application modules 310-314 may be exchanged through an interprocess communication (IPC). In at least one embodiment, a shared messaging queue is utilized to exchange data between the screen management module 304 and the application modules 310-314.

The application modules 310-314 identify a particular graphical interface to be presented by the screen management module 304. The screen management module 304 retrieves assets relating to the identified graphical interface from the memory 214 and/or the storage medium 216 and identifies the layout of the graphical interface based on the assets. The screen management module 304 then transmits the layout of the graphical interface to the output management module 306 for output to the display device 104.

The screen management module 304 is also operable to receive input from the input management module 302 and transfer the input to the appropriate application module 310-314 related to the graphical interface holding focus. For example, a main menu of the television receiver 102A may be displayed by the display device 104 when the user provides a certain key press via the remote control 106. The screen management module 304 receives the translated input from the input management module 306 and transfers the input to the appropriate application module 310-314 associated with the main menu.

The output management module 306 operates as an interface between the hardware of the television receiver 102A and the screen management module 304. The output management module 306 is operable to handle drawable widgets and interface with various rendering libraries operating on the television receiver 102A. Thus, in at least one embodiment, the screen management module 304 is independent from the hardware of the output interface 210. In at least one embodiment, the output management module 306 outputs the graphical interface as Open-GL commands that are utilized by the output interface 210 to render the graphical interface for presentation by the display device 104.

Graphical Interface Stack

In at least one embodiment, a simple stack is maintained to hold graphical interfaces. When a graphical interface is first initialized, a control structure is created for the graphical interface. This control structure contains the current graphical interface stack. In at least one embodiment, a base graphical interface is pushed onto the stack at a base position. As new graphical interfaces are drawn, other graphical interfaces may be destroyed or hidden depending on desired design criteria. For example, one graphical interface may be destroyed responsive to a command to draw another graphical interface. In some embodiments, graphical interfaces may continue to be visible under newly drawn graphical interface. For example, a smaller graphical interface may be drawn upon a larger graphical interface that continues to be visible in the background. Graphical interfaces may be destroyed in the order they were pushed into the stack to prevent memory leaks and/or corruption.

Graphical Interface Creation

In at least one embodiment, the screen management module 304 is operable to implement a mutex lock around a graphical interface creation, preventing the graphical interface from being available to multiple users. Graphical interfaces may be allowed to stack on top of one another by the screen management module 304. For example, when the user 110 traverses multiple menus or handles modal focus pop-ups, then the screen management module 304 may stack graphical interfaces on top of one another.

Graphical Interface Layout

In at least one embodiment, the layout of graphical interfaces is controlled via the use of frame widgets or container widgets. Frame widgets are graphical interface widgets that can be layered over other graphical interface widgets. Container widgets are graphical interface widgets that cannot be layered. A graphical interface is broken up into its graphical interface widget components. In at least one embodiment, widgets contain information regarding the area in which they are to be created and build a tree hierarchy. The traversal of the tree hierarchy by cursors or other focus elements is described in greater detail below.

Graphical Interface Layering

Graphical interface layering involves drawing a new graphical interface on top of the current graphical interface. This may occur in several ways. For example, when a graphical interface proceeds to the next graphical interface, it may push itself into a hide state. This causes the graphical objects associated with the graphical interface to cease drawing. In at least one embodiment, the control block for the graphical interface is pushed onto the graphical interface stack and becomes invisible, but is saved and ready to return to active state upon request.

When a graphical interface is exiting, it may destroy itself and the widgets associated with the graphical interface. This frees memory allocated to the graphical interface. The screen management module 304 may then remove the next available graphical interface from the stack and return the next available graphical interface to an active state for rendering by the output management module 306.

In some embodiments, it may be desired to create a graphical interface on top of another graphical interface without hiding the previous graphical interface. For example, modal pop-up graphical interfaces are typically drawn over a previously presented graphical interface. In this case, the graphical interface displays the pop but the previous graphical interface does not go into a hide state. Rather, the previous graphical interface goes into an inactive state, which removes focus from the widgets of the previous graphical interface. Thus, in at least one embodiment, the input management module 302 temporarily stops processing input to the previous graphical interface. The control structure of the previous graphical interface may be further pushed onto the graphical interface stack until removal of the modal graphical interface.

In at least one embodiment, the new graphical interface object (e.g., the modal dialog) is created as a transparent container object. This creates a frame in the center of the graphical interface, which is drawn over the graphical interface behind it. The graphical interface is visible in the background of the pop-up dialog, but cannot get focus until the pop-up dialog is removed. When the top graphical interface is removed, the next graphical interface is popped off the graphical interface stack and changes to an active state.

Focus

The focus of widgets may be a layered process depending on which widget is capable of handler motion events. Generally, the checking process occurs first in relation to the graphic widget with focus, then with container widgets up the chain and then the main graphical interface. In at least one embodiment, if none of these elements can handle the navigation request, then a non-focus return code is returned and the focus is maintained on the current widget maintaining focus.

In some embodiments, the focus is not allowed to move from a spot within a modal graphical interface. For example, when a pop-up is created, the pop-up should draw to the front of the graphical interface and not lose focus until the user selects an option and the graphical interface destroys itself. Thus, graphical interfaces in the background of a modal graphical interface should be marked as inactive and cannot have focus.

Actions

Events within a graphical interface may include any action that is triggered by the user. For example, events may include input from remote control, front panels (e.g., button presses on the television receiver 102A), keyboards, microphones and other input devices. Events are captured by the remote control 106 (or other input device) and transmitted to the input interface 212. The input management module 302 receives the input from the input interface 212 and translates the input into an event for processing by the screen management module 304.

In at least one embodiment, the screen management module 304 processes the event to identify whether a listener associated with the graphical interface has been configured for the event. If the listener has been configured, then a listener callback function may be called responsive to the event. If no listener has been configured, then the screen management module 304 processes the input to determine whether the current focus widget can handle the event. If the focus widget cannot handle the event, then the event traverses up the widget hierarchical structure parent to parent. If the input reaches the graphical interface parent and has not been handled, then the input may be discarded.

Event Definition

Events may contain both a type of event and a name of the event. In at least one embodiment, the screen management module 304 receives information regarding both the event type and name from the input management module 302. For example, an event type may be designated BUTTON_DOWN, indicating a button was depressed, BUTTON_UP, indicates a button was released and MOUSE_OVER indicates the mouse pointer has moved. Event names, such as select, guide, menu, up, down, left and right designate the particular button that was pressed or depressed by the user 110 (see FIG. 1).

Messages

Application modules 310-314 may originate messages, which are passed into the screen management module 304. Messages can be handled through an entire graphical interface stack and up to a global message handler. For example, the screen management module 304 may pass messages through the graphical interface stack from top to bottom. A global message handling module processes messages that are available in the graphical interface stack but cannot be processed by any graphical interfaces. If the message has not been handled through the graphical interface stack, then the message may be discarded.

In at least one embodiment, it may be desirable to prevent global messages during certain operations. For example, it may not be desirable to pop-up unrelated global messages (e.g., a caller identification (ID) dialog) during a checkswitch operation of the television receiver 102A (see FIG. 2). Thus, the screen management module 304 may be configured to prevent a global message handler from processing the global message during the pendency of the checkswitch operation.

The screen management module 304 is capable of supporting multiple application modules 310-314 simultaneously. In some embodiments, separate instances of the screen management module 304 may be utilized to support multiple application modules 310-314 or even multiple graphical interfaces within a particular application module 310-314. In at least one embodiment, communication between multiple graphical interfaces is allowed through a defined protocol. Graphical interfaces may also export some functions which can be accessed by related graphical interfaces and pop-ups. Illustrated below are various functionalities and operations of the screen management module 304 that may be implemented depending on desired design criteria.

Those of ordinary skill in the art will appreciate that the various functional elements 302 through 306 shown as operable within the television receiver 102A may be combined into fewer discrete elements or may be broken up into a larger number of discrete functional elements as a matter of design choice. For example, the input management module 302 and/or the output management module 306 may be combined with the screen management module 304. Thus, the particular functional decomposition suggested by FIG. 3 is intended merely as exemplary of one possible functional decomposition of elements within the television receiver 102A.

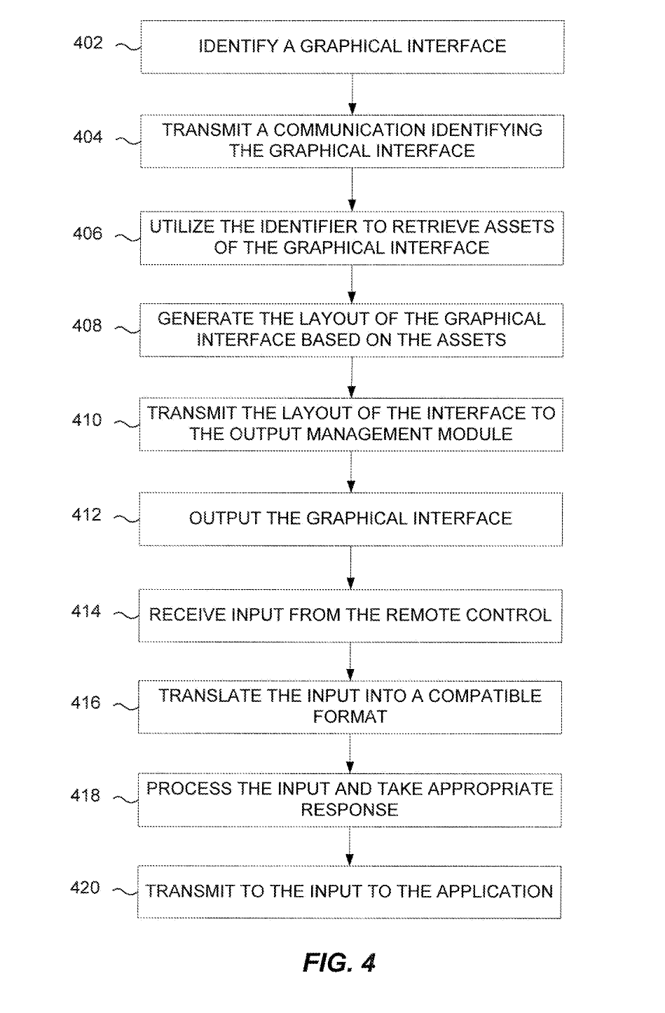

FIG. 4 illustrates a process for presenting a graphical interface. The process of FIG. 4 will be described in reference to the entertainment system 100 illustrated in FIGS. 1-3. The process of FIG. 4 may include other operations not illustrated for the sake of brevity,

In operation 402, an application module 310 identifies a graphical interface for presentation to the user 110. For example, the user 110 may provide input requesting to view an electronic programming guide and the graphical interface may present the electronic programming guide information to the user 110. In at least one embodiment, the graphical interface is associated with one or more assets. For example, the graphical interface may be associated with an XML file that describes the layout of particular graphical elements of the interface, such as buttons, list boxes, video elements, containers and the like. In some embodiments, the assets may be specific graphical elements of the interface, such as images, sounds, videos and the like.

In operation 404, the application module 310 transmits a communication to the screen management module 304 identifying the graphical interface. For example, the graphical interface may be associated with a unique identifier. The screen management module 304 utilizes the identifier to initiate retrieval of the assets associated with the graphical interface from a storage medium 216 and/or the memory 214 (operation 406).

In operation 408, the screen management module 304 generates the graphical interface based on the asset. For example, the asset may be an XML file describing the layout of the graphical interface and the screen management module 304 may parse the XML file to identify the locations of the graphical elements to be presented to the user 110. In at least one embodiment, the asset may be a C language file or the like specifying the various elements of the graphical interface. These commands may be processed by a rendering engine to output the graphical interface.

In operation 410, the screen management module 304 transmits the layout of the graphical interface to the output management module 306. The output management module 306 and the output interface 210 cooperatively operate to output the graphical interface for presentation by the display device 104 (operation 412).

In operation 414, the input management module 302 receives input from the remote control 106 via the input interface 212. In at least one embodiment, the input is associated with a graphical interface widget, e.g., a button, and the screen management module 304 is operable for determining whether the input is compatible with the widget. For example, the input management module 302 may include listeners for particular types of input associated with a widget, such as particular button presses which are expected for a specific graphical interface.

The input management module 302 translates the input into a format compatible with the screen management module 304 and/or the application module 310 and transmits the input to the screen management module 304 (operation 416). The screen management module 304 processes the input and takes appropriate response, such as changing the look of a button responsive to a button press (operation 418). If applicable, the input is then transmitted from the screen management module 304 to the application module 310 for further processing (operation 420). For example, the application module 310 may receive the input and identify a different graphical interface to present responsive to the input or may perform a specific functionality responsive to the input, such as setting a recording timer or changing a channel.

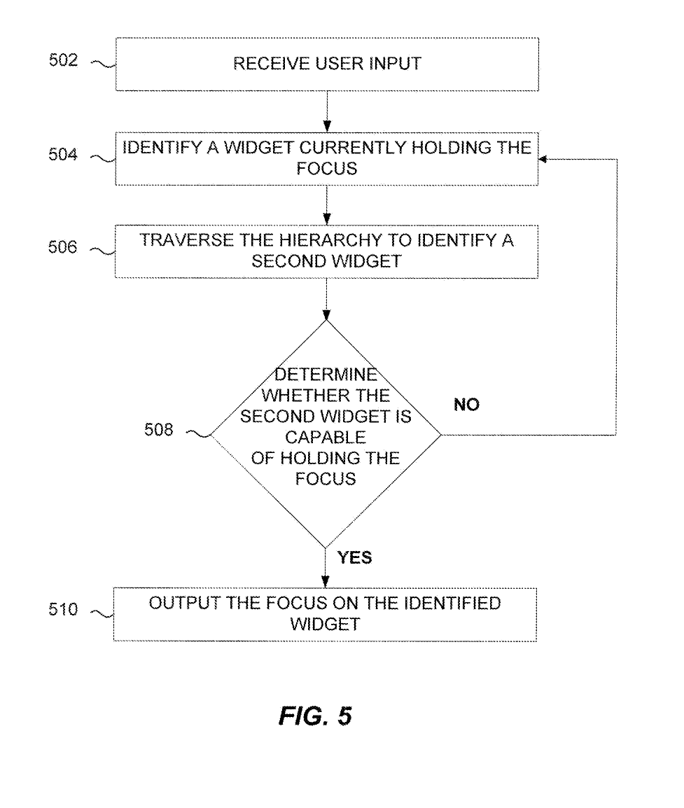

FIG. 5 illustrates a process for presenting a graphical interface. More particularly, FIG. 5 illustrates a process for navigating the hierarchical structure of a graphical interface. The process of FIG. 5 will be described in reference to the entertainment system 100 illustrated in FIGS. 1-3. The process of FIG. 5 may include other operations not illustrated for the sake of brevity.

The process includes receiving user input requesting to move a focus of the graphical interface (operation 502). For example, the input management module 302 may receive input from the remote control 106 (see FIG. 1) via the input interface 212. In at least one embodiment, the graphical interface includes a plurality of widgets organized in a hierarchical structure. For example, the graphical interface may be at the top of the hierarchy and may be divided into several containers, each representing a branch of the hierarchical structure. Each container may include various elements or sub-containers which comprise further branches of the hierarchical structure.

The process further includes identifying a first of a plurality of widgets holding the focus in the graphical interface (operation 504). For example, the screen management module 304 may include a pointer, register or other location storing a value of the widget currently holding focus in the graphical interface.

The process further includes traversing the hierarchy to identify a second of the widgets meeting a criterion of the user input (operation 506). For example, the user input may request to move up to a higher element in the graphical interface. Thus, a widget meeting the criterion of the user input may be higher in the structure. Similarly, a move left request may select a widget that is a different branch of parent of the widget currently holding focus. The process further includes determining whether the second widget is capable of holding the focus (operation 508). The process may include traversing up the hierarchical structure and checking whether each traversed node of the hierarchical structure can hold the focus. If not, the screen management module 304 keeps moving up the hierarchical structure until it finds a widget meeting the criterion of the user input that is capable of maintaining the focus. Responsive to determining that the second widget is capable of holding the focus, the process further includes outputting the focus on the second widget in the graphical interface (operation 510).

Navigation

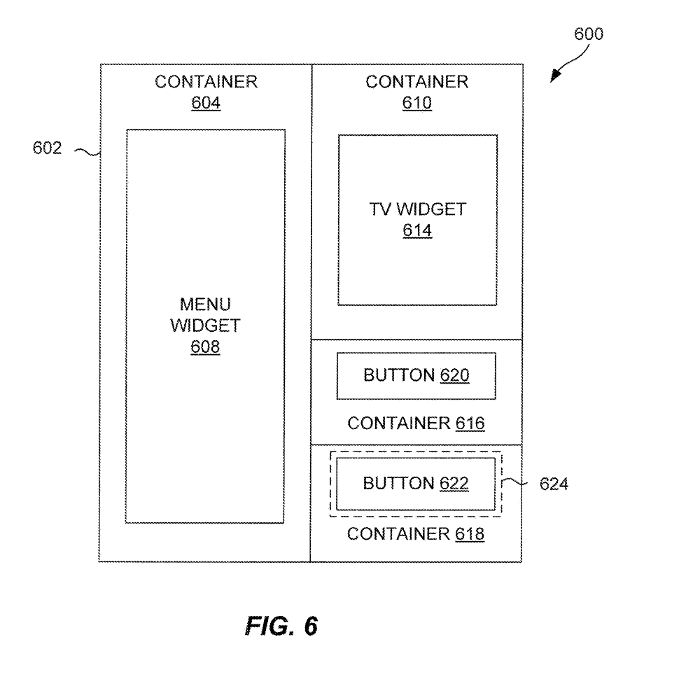

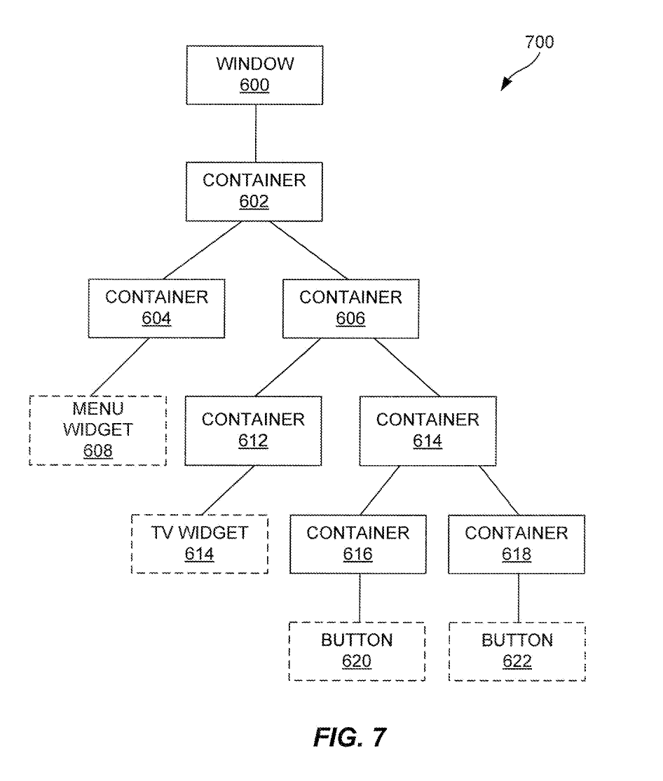

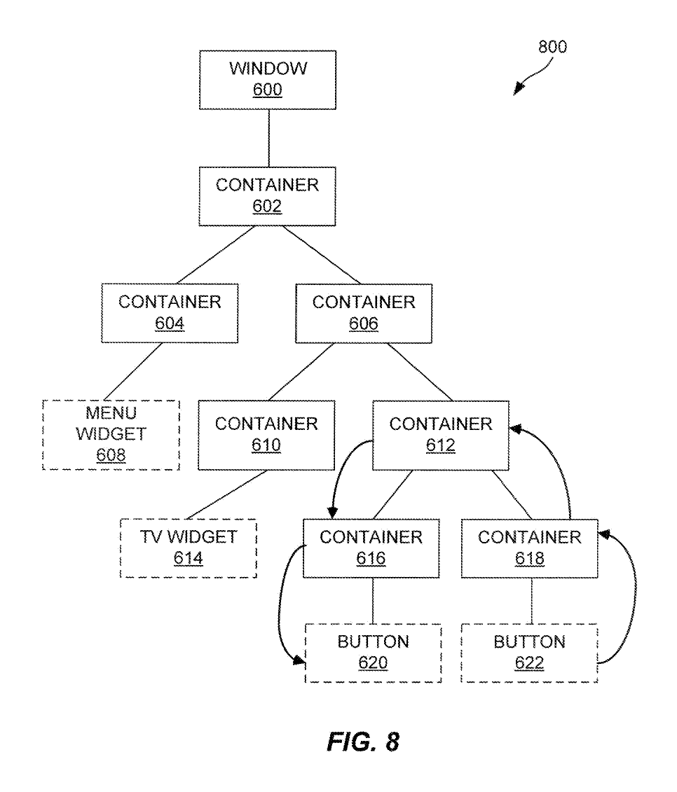

FIG. 6 illustrates an example of a graphical interface 600. FIG. 7 illustrates the hierarchy 700 of the components in graphical interface 600 of FIG. 6. The graphical interface 600 includes a base container 602. The base container 602 is split into two containers, including a left container 604 and a right container 606 (not shown in FIG. 6), which includes the containers 610, 616 and 618. The left container 604 includes a menu widget 608. The right container is further split into a top container 610 and a bottom container 612 (not shown in FIG. 6), which includes containers 616 and 618. The top container 610 includes a TV widget 614. The bottom container is further split into containers 616 and 618, which include buttons 620 and 622, respectively. As illustrated in FIG. 6, the current focus 624 is on button 620. The components 602-622 of the graphical interface 600 are laid out as illustrated in FIG. 6.

Navigation starts with the current widget in focus. Navigation stops on a widget that can receive focus. In some embodiments, containers and frames may not be focusable widgets. In FIG. 7, elements capable of receiving focus are illustrated with dashed lines.

As the user 110 provides input, the screen management module 304 determines whether input is compatible with a widget. If the input is not compatible with the widget, then the screen management module 304 navigates the hierarchy to locate a widget compatible with the input as illustrated in the hierarchy 800 of FIG. 8. For example, if the current focus 624 is on button 622 and a left key input is received, then the input is not compatible with the button 622. The input is passed to container 618, which cannot handle the focus. The input is then passed to container 612, which passes the input to the container 616. The container 616 cannot handle the input and passes the input to the button 620. Responsive to the input, the focus 624 is changed to the button 620.

In some embodiments, the input cannot be handled lower in the hierarchy 700 is and passed up to the top level of the hierarchy 700 (e.g., the graphical interface 600). It at least one embodiment, if the top level cannot handle the input (e.g., change the focus), then the input is discarded. It at least one embodiment, a layered frame is expected to remain focus. If a widget cannot handle the focus, then the frame may be destroyed.

Although specific embodiments were described herein, the scope of the invention is not limited to those specific embodiments. The scope of the invention is defined by the following claims and any equivalents therein.

We claim:

1. An apparatus comprising:
a storage medium that stores at least one asset relating to at least one graphical interface;
at least one processor;
an application module operating on the processor, the application module operable to identify the graphical interface;
an application independent screen management module operating on the processor, the screen management module operable to receive a communication from the application module identifying the graphical interface, initiate retrieval of the asset from the storage medium and identify the layout of the graphical interface based on the asset; and
an output interface that receives the layout and outputs the graphical interface for presentation by a presentation device.

2. The apparatus of claim 1, further comprising an input management module operating on the processor that is associated with the screen management module, the input management module operable to receive input from an input device, translate the input into a format compatible with the application module and initiate transmission of the translated input to the application module for further processing.

3. The apparatus of claim 2, wherein the input is associated with a widget of the graphical interface and the input manager is further operable to determine whether the input is compatible with the widget and translate the input responsive to determining that the input is compatible with the widget.

4. The apparatus of claim 2, wherein the application module and the screen management module exchange data using a shared messaging queue.

5. The apparatus of claim 1, wherein the asset includes a description of the layout of the graphical interface.

6. The apparatus of claim 5, wherein the layout is stored in an XML format and the graphical interface manager is operable to parse the XML format data to generate the graphical interface for output by the output interface.

7. The apparatus of claim 1, wherein the apparatus comprises a television receiver.

8. An apparatus comprising:
a storage medium that stores a graphical interface, the graphical interface including a plurality of widgets, the widgets organized in a hierarchical structure;
an output interface operable to output the graphical interface to a presentation device;
an input interface operable to receive user input requesting to move a focus of the graphical interface;
a processor operable to:
identify a first of the widgets holding the focus in the graphical interface;
traverse the hierarchical structure to identify a second of the widgets meeting a criterion of the user input;
determine whether the second widget is capable of holding the focus; and
responsive to determining that the second widget is capable of holding the focus, commanding the output interface to output the focus on the second widget in the graphical interface.

9. The apparatus of claim 8, the processor further operable to:
responsive to determining that the second widget is not capable of holding the focus, identifying a third of the widgets having a position higher in the hierarchical structure than the second widget;
determine whether the third widget is capable of holding the focus; and
responsive to determining that the third widget is capable of holding the focus, command the output interface to output the focus on the third widget in the graphical interface.

10. The apparatus of claim 8, wherein the processor is operable to traverse to a highest position of the hierarchical structure and discard the user input responsive to identifying that none of the widgets traversed are capable of holding the focus.

11. The apparatus of claim 8, further comprising:
an application independent screen management module operating on the processor, the screen management module operable to receive a communication from the application module identifying the graphical interface, initiate retrieval of the widgets from the storage medium and generate the graphical interface based on the widgets;
wherein the output interface receives the graphical interface and outputs the graphical interface for presentation by a presentation device.

12. The apparatus of claim 10, wherein the screen management module translates the user input into a format compatible with the application module and transmits the translated input to the application module for further processing.

13. A method of presenting a graphical interface, the method comprising:
identifying a graphical interface in an application module operating on a processor, the graphical interface associated with at least one asset;
receiving, in an application independent screen management module operating on the processor, a communication from the application module identifying the graphical interface;
initiating retrieval of the asset from the storage medium;
generating the graphical interface in the screen management module based on the asset; and
outputting the graphical interface for presentation by a presentation device.

14. The method of claim 13, further comprising:
receiving input, at the screen management module, from an input device;
translating the input, at the screen management module, into a format compatible with the application module; and
transmitting the translated input to the application module for further processing.

15. The method of claim 13, wherein the input is associated with a widget of the graphical interface, the method further comprising:
determining, in the screen management module, whether the input is compatible with the widget;
wherein translating the input and transmitting the translated input is performed responsive to determining that the input is compatible with the widget.

16. The method of claim 13, wherein receiving, in an application independent screen management module operating on the processor, a communication from the application module further comprises:
transmitting the communication from the application module to the screen management module through a shared messaging queue.

17. The method of claim 13, wherein generating the graphical interface further comprises:
retrieving the asset from the storage medium, the asset including an XML file describing a layout of widgets in the graphical interface; and
parsing the XML file to generate the graphical interface.

18. A method for presenting a graphical interface, the method comprising:
receiving user input requesting to move a focus of the graphical interface, the graphical interface including a plurality of widgets organized in a hierarchical structure;
identifying a first of a plurality of widgets holding the focus in the graphical interface;
traversing the hierarchical structure to identify a second of the widgets meeting a criterion of the user input;
determining whether the second widget is capable of holding the focus; and
responsive to determining that the second widget is capable of holding the focus, outputting the focus on the second widget in the graphical interface.

19. The method of claim 18, further comprising:
responsive to determining that the second widget is not capable of holding the focus, identifying a third of the widgets having a position higher in the hierarchical structure than the second widget;
determining whether the third widget is capable of holding the focus; and
responsive to determining that the third widget is capable of holding the focus, outputting the focus on the third widget in the graphical interface.

20. The method of claim 18, further comprising:
identifying a graphical interface in an application module operating on a processor, the graphical interface associated with at least one asset;
receiving, in an application independent screen management module operating on the processor, a communication from the application module identifying the graphical interface;
initiating retrieval of the asset from the storage medium;
generating the graphical interface in the screen management module based on the asset; and
outputting the graphical interface for presentation by a presentation device.
